(19) United States
(12) Patent Application Publication
(10) Pub. No.: US 2022/0404574 A1
(43) Pub. Date: Dec. 22, 2022

(54) PRECONNECTORIZED DISTRIBUTION CABLE ASSEMBLIES AND METHODS OF MAKING BY JACKET SEGMENTATION

(71) Applicant: CORNING RESEARCH & DEVELOPMENT CORPORATION, Corning, NY (US)

(72) Inventors: Terry Lee Cooke, Hickory, NC (US); Michael Todd Faulkner, Granite Falls, NC (US); Lars Kristian Nielsen, Denver, NC (US)

(21) Appl. No.: 17/893,510

(22) Filed: Aug. 23, 2022

Related U.S. Application Data
(63) Continuation of application No. PCT/US2021/018309, filed on Feb. 17, 2021.
(60) Provisional application No. 62/986,118, filed on Mar. 6, 2020.

(51) Int. Cl. G02B 6/44

(52) U.S. Cl. CPC G02B 6/4486; G02B 6/4475

(57) ABSTRACT

Disclosed herein are preconnectorized cable assemblies and methods of making by cable segmentation. One method includes making cable assemblies by adding jacket segments around a cable bundle including a plurality of cable units having at least one optical fiber, and then attaching the plurality of jacket segments together. Another method includes making cable assemblies by inserting jacket segments between base jacket portions. The method includes circumferentially cutting a ring cut in a base jacket surrounding a cable bundle having a plurality of subunit cables with at least one optical fiber. An insert jacket segment is then positioned around the cable bundle and inserted within an access window in the base jacket. The insert jacket segment is joined along a longitudinal slit and ends of the insert jacket segment are attached to the base jacket. A subunit cable of the cable bundle extends through the first side opening.

### PRIORITY APPLICATION

This application is a continuation of International Patent Application No. PCT/US2021/018309 filed Feb. 17, 2021, which claims the benefit of priority of U.S. Provisional Application No. 62/986,118, filed on Mar. 6, 2020, the content of which is relied upon and incorporated herein by reference in its entirety.

### BACKGROUND

The present disclosure relates to preconnectorized optical cable assemblies with and methods of making by jacket segmentation.

Data center design and cabling-infrastructure architecture are increasingly large and complex, which requires incorporation of high density optical components (e.g., optical fiber densities), such as to compensate for limited space and meet increasing performance demands. Many data centers include fiber optic cables which have a number of advantages in waveguide systems compared to bulky traditional conductor cables (e.g., copper). Fiber optic cables provide wide bandwidth data transmission, transport multiple signals and traffic types, and/or deliver high-speed Internet access, especially as data rates increase. Data centers utilize multi-fiber cables to interconnect and provide signals between building distribution frames and/or to individual unit centers (e.g., computer servers). However, the labor and cost of deployment of such multi-fiber cable networks for a data center can be high. Thus, there is a desire to reduce the time and costs associated with data center construction, particularly regarding cabling installation.

One way to improve optical infrastructure installation efficiency is to pre-engineer infrastructure components. Such components (e.g., fiber optic cables) may be preterminated in a factory with connectors installed, tested, and packaged for fast, easy, and safe installation at a data center. In this way, the installer merely needs to unpacks the components, pull or route the preconnectorized fiber optic cable assembly, snap in connectors, and/or install patch cords to end equipment, etc. This saves a significant amount of time, effort, and costs compared to on-site connectorization and assembly of cables.

Pre-engineering such components presents challenges to decrease costs, waste, and/or effort in assembling such pre-configured multi-fiber optical cables to enable efficient handling, maintenance, and/or installation.

### SUMMARY

One embodiment of the disclosure relates to a method of making a distribution cable assembly. The method includes providing a cable bundle including a plurality of cable subunits. Each of the plurality of cable subunits includes at least one optical fiber. The cable bundle is devoid of an outer jacket of a distribution cable. The method further includes positioning a plurality of segments of a jacket of a distribution cable around the cable bundle. The method further includes attaching the plurality of segments together to form the jacket of the distribution cable.

An additional embodiment of the disclosure relates to a method of making a distribution cable assembly. The method includes circumferentially cutting a first ring cut at a first predetermined location in a base jacket surrounding a cable bundle. The cable bundle includes a plurality of subunit cables. Each of the plurality of subunit cables includes at least one optical fiber. The method further includes inserting a first insert jacket segment around the cable bundle within a first access window between two base jacket portions at least partially formed by the first ring cut. The first insert jacket segment includes a longitudinal slit and a first side opening. The method further includes joining the first insert jacket segment along the longitudinal slit. The method further includes attaching each end of the first insert jacket segment to the two base jacket portions to form the jacket of the distribution cable. The method further includes extending a first subunit cable of the plurality of subunit cables of the cable bundle through the first side opening.

Additional features and advantages will be set out in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a perspective view of a section of fiber optic distribution cable, in accordance with aspects of the present disclosure.

FIG. 1B is a perspective view of a section of a subunit cable of the distribution cable of FIG. 1A, in accordance with aspects of the present disclosure.

FIG. 2A is a cross-sectional view of an embodiment of the distribution cable of FIGS. 1A-1B, in accordance with aspects of the present disclosure.

FIG. 2B is a cross-sectional view of another embodiment of the distribution cable of FIGS. 1A-1B, in accordance with aspects of the present disclosure.

FIG. 3A is a schematic view of an embodiment of a preconnectorized distribution cable assembly including the distribution cable of FIGS. 1A-2B and illustrating a distribution tether with MTP connectors and eight subunit cables with MTP connectors.

FIG. 3B is a schematic view of another embodiment of a preconnectorized distribution cable assembly including the distribution cable of FIGS. 1A-2B and illustrating a distribution tether with MTP connectors and eight tether subunits with LC uniboot connectors.

FIG. 3C is a schematic view of another embodiment of a preconnectorized distribution cable assembly including the distribution cable of FIGS. 1A-2B and illustrating multiple distribution tethers and multiple tap tethers.

FIG. 4A is a schematic view of a data center for use with the distribution cable assemblies of FIGS. 3A-3C, in accordance with aspects of the present disclosure.

FIG. 4B is a schematic view of equipment racks and distribution cables in the data center of FIG. 4A, in accordance with aspects of the present disclosure.

FIG. 5A is a side view of a coupling shell attaching two distribution jackets, in accordance with aspects of the present disclosure.

FIG. 5B is a side view of a junction shell attaching two distribution jackets and a tap jacket, in accordance with aspects of the present disclosure.

FIG. 6A is a schematic view illustrating assembly of a distribution cable assembly by consecutive addition of jacket segments around a cable bundle, in accordance with aspects of the present disclosure.

FIG. 6B is a perspective view of a first jacket segment around a cable bundle illustrating one step of the assembly of FIG. 6A, in accordance with aspects of the present disclosure.

FIG. 6C is a perspective view of a subunit cable peeled from the cable bundle illustrating another step of the assembly of FIG. 6A, in accordance with aspects of the present disclosure.

FIG. 6D is a perspective view of a second jacket segment around the cable bundle with the subunit cable extending through a side opening of the second jacket segment illustrating another step of the assembly of FIG. 6A, in accordance with aspects of the present disclosure.

FIG. 7A is a schematic view illustrating assembly of a distribution cable assembly by consecutive addition of base jacket segments around a cable bundle and insertion of windowed jacket segments between the base jacket segments, in accordance with aspects of the present disclosure.

FIG. 7B is a perspective view of a subunit cable peeled from the cable bundle illustrating another step of the assembly of FIG. 7A, in accordance with aspects of the present disclosure.

FIG. 7C is a perspective view of an windowed jacket segment around the cable bundle between the base jacket segments with the subunit cable extending through a side opening of the windowed jacket segment illustrating another step of the assembly of FIG. 7A, in accordance with aspects of the present disclosure.

FIG. 8A is a perspective view of a base jacket around a cable bundle with a ring cut in the base jacket to form two base jacket portions, in accordance with aspects of the present disclosure.

FIG. 8B is a perspective view of one base jacket portion slid relative to the other base jacket portion to form an access window between the two base jacket portions, in accordance with aspects of the present disclosure.

FIG. 9A is a perspective view of a base jacket segment between two base jacket portions formed by two ring cuts and a longitudinal split therebetween, in accordance with aspects of the present disclosure.

FIG. 9B is a perspective view of removal of the base jacket segment to form an access window between the two base jacket portions, in accordance with aspects of the present disclosure.

FIG. 10A is a perspective view of attachment of a junction shell to cover the junction of the subunit cable with the jacket of the distribution cable illustrating another step of the assemblies of FIGS. 5A-9B, in accordance with aspects of the present disclosure.

FIG. 10B is a perspective view of furcation of a tap end of the subunit cable illustrating another step of the assemblies of FIGS. 5A-9B, in accordance with aspects of the present disclosure.

FIG. 11 is a flowchart of steps for making a distribution cable assembly using consecutive addition of jacket segments, in accordance with aspects of the present disclosure.

FIG. 12 is a flowchart of steps for making a distribution cable assembly using insertion of jacket segments, in accordance with aspects of the present disclosure.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The embodiments set out below represent the information to enable those skilled in the art to practice the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

### Reference Numbers and Terminology

The use herein of ordinals in conjunction with an element is solely for distinguishing what might otherwise be similar or identical labels, such as “first layer” and “second layer,” and does not imply a priority, a type, an importance, or other attribute, unless otherwise stated herein.

The term “about” used herein in conjunction with a numeric value means any value that is within a range of ten percent greater than or ten percent less than the numeric value.

As used herein, the articles “a” and “an” in reference to an element refers to “one or more” of the element unless otherwise explicitly specified. The word “or” as used herein is inclusive unless contextually impossible. As an example, the recitation of A or B means A, or B, or both A and B.

The phrase “surface” as used herein refers to an outermost portion of an item, and includes a thickness of the outermost portion of the item. The precise thickness is generally not relevant to the embodiments, unless otherwise discussed herein. For example, a layer of material has a surface which includes the outermost portion of the layer of material as well as some depth into the layer of material, and the depth may be relatively shallow, or may extend substantially into the layer of material. The sub-wavelength openings discussed herein are formed in a surface, but whether the depth of the sub-wavelength openings extends past the depth of the surface is generally not relevant to the embodiments.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The use herein of “proximate” means at, next to, or near.

The terms “left,” “right,” “top,” “bottom,” “front,” “back,” “horizontal,” “parallel,” “perpendicular,” “vertical,” “lateral,” “coplanar,” and similar terms are used for convenience of describing the attached figures and are not intended to limit this disclosure. For example, the terms “left side” and “right side” are used with specific reference to the drawings as illustrated and the embodiments may be in other orientations in use. Further, as used herein, the terms “horizontal,” “parallel,” “perpendicular,” “vertical,” “lateral,” etc., include slight variations that may be present in working examples.

As used herein, the terms “optical communication,” “in optical communication,” and the like mean that two elements are arranged such that optical signals are passively or actively transmittable therebetween via a medium, such as, but not limited to, an optical fiber, connectors, free space, index-matching structure or gel, reflective surface, or other light directing or transmitting means.

As used herein, the term “port” means an interface for actively or passively passing (e.g., receiving, transmitting, or both receiving and transmitting) optical signals. A port may include, by way of non-limiting examples, one or more collimators, pigtails, optical connectors, optical splices, optical fibers, free-space, or a combination of the foregoing. In the context of a WDM assembly, a port is the location at which one or more optical signals enters and/or exist the WDM assembly.

As used herein, the term “pigtail” means one or more optical fibers that extend from a ferrule. The one or more optical fibers may each be terminated with a fiber optical connector but are not required to be terminated with a fiber optic connector.

### Data Centers and Fiber Optic Cable Assemblies

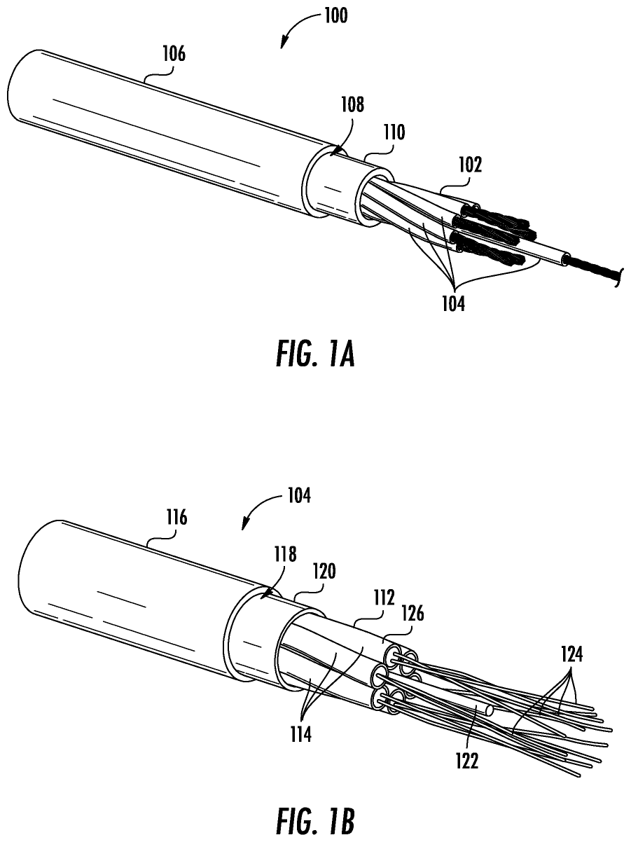

FIGS. 1A-1C are views of a section of a fiber optic distribution cable 100, in accordance with aspects of the present disclosure. Referring to FIG. 1A, the distribution cable 100 includes a cable bundle 102 (may also be referred to herein as a cable core) of a plurality of subunit cables 104 and a distribution jacket 106 (may also be referred to as outer jacket, etc.) defining a distribution interior 108. The cable bundle 102 of the subunit cables 104 is disposed in the distribution interior 108 of the distribution jacket 106. In certain embodiments, the distribution jacket 106 is formed from, for example, a flame-retardant polymer material.

In certain embodiments, a strain-relief component 110 may be disposed within the distribution interior 108 of the distribution jacket 106 between the cable bundle 102 of the subunit cables 104 and the distribution jacket 106. The strain-relief component 110 surrounds and/or is interspersed among the cable bundle 102 of the subunit cables 104. In certain embodiments, the strain-relief component 110 may be, for example, a layer of longitudinally-extending yarns for absorbing tensile loads on the cable bundle 102. In certain embodiments, the strain-relief component 110 includes a dispersed layer of aramid strands in the region between the distribution jacket 106 and the cable bundle 102 of subunit cables 104.

In the illustrated embodiment, the cable bundle 102 has eight subunit cables 104. However, other embodiments could include more or fewer subunit cables 104 depending on cabling requirements. In certain embodiments, one or more layers of subunit cables 104 may be provided depending on the fiber densities needed and/or other desired parameters (e.g., limitations on the outside diameter of the distribution cable 100). The distribution cable 100 and/or the subunit cables 104 may have generally circular cross-sections, although other cross-sections (e.g., oval, elliptical, etc.) may be used. The illustrated cables and subunit cables may not have perfectly circular cross-sections, and any citations of diameters may represent an average diameter of a generally circular cross-section. In certain embodiments, as illustrated, the cable bundle 102 is stranded such that the subunit cables 104 are helically twisted around a longitudinal axis of the cable bundle 102. In certain embodiments, an outer layer of a plurality of subunit cables 104 is stranded around an inner layer of subunit cables 104 to provide higher fiber densities. This reduces any stress or strain concentrations on any one subunit cable 104 (e.g., from bending of the distribution cable 100). In certain embodiments, a central strength element (not shown) may be provided and the subunit cables 104 may be stranded around the central strength element. In yet other cable applications, stranding may not be used and the subunit cables 104 may run substantially parallel through the distribution cable 100.

Referring to FIG. 1B, each subunit cable 104 (may also be referred to herein as a micromodule, etc.) includes a subunit bundle 112 (may also be referred to herein as a subunit core) of a plurality of tether cables 114 (may also be referred to herein as tether subunits) and a subunit jacket 116 defining a subunit interior 118. The subunit bundle 112 of the tether cable 114 is disposed in the subunit interior 118 of the subunit jacket 116. In certain embodiments, the subunit jacket 116 is formed from, for example, a flame-retardant polymer material.

In certain embodiments, a strain-relief component 120 may be disposed within the subunit interior 118 of the subunit jacket 116 between the subunit bundle 112 of the tether cables 114 and the subunit jacket 116. The strain-relief component 120 surrounds and/or is interspersed among the subunit bundle 112 of the subunit cables 104. In certain embodiments, the strain-relief component 120 may be, for example, a layer of longitudinally-extending yarns for absorbing tensile loads on the subunit bundle 112. In certain embodiments, the strain-relief component 120 includes a dispersed layer of aramid strands in the region between the subunit jacket 116 and the subunit bundle 112 of tether cables 114.

In certain embodiments, a central strength element 122 may be disposed in a center of the subunit bundle 112, and thereby within the subunit interior 118 of the subunit jacket 116. The tether cables 114 may be stranded (e.g., helically twisted) around the central strength element 122. In certain embodiments, an outer layer of a plurality of tether cables 114 is stranded around an inner layer of tether cables 114 to provide higher fiber densities. In yet other cable applications, stranding may not be used and the tether cables 114 may run substantially parallel through the subunit cable 104. The central strength element 122 provides strain-relief and absorbs loads from the tether cables 114.

In the illustrated embodiment, the subunit bundle 112 has six tether cables 114. However, other embodiments could include more or fewer tether cables 114 depending on cabling requirements. In certain embodiments, one or more layers of tether cables 114 may be provided depending on the fiber densities needed and/or other desired parameters (e.g., limitations on the outside diameter of the distribution cable 100). In certain embodiments, as illustrated, the subunit bundle 112 is stranded such that the tether cables 114 are helically twisted around a longitudinal axis of the subunit bundle 112. This reduces any stress or strain concentrations on any one tether cable 114 (e.g., from bending of the distribution cable 100 and/or subunit cable 104).

Each tether cable 114 includes one or more optical fibers 124 (may also be referred to herein as optical fiber waveguides). In certain embodiments, the optical fibers 124 in the subunit cable 104 may be furcated into separate tether cables 114 within the core of the subunit cable 104. Each tether cable 114 may include a tether jacket 126 to surround a select number of optical fibers 124 in the tether cable 114. As an example, as illustrated, each subunit cable 104 includes six tether cables 114, and each tether cable 114 includes two optical fibers 124. In other words, each subunit cable 104 includes 12 optical fibers 124. Other numbers of subunit cables 104, and/or tether cables 114, and/or optical fibers 124 can be employed for various applications, however. For example, in certain embodiments, each subunit cable 104 includes 2-24 optical fibers. Further, the diameters and thicknesses of the distribution cable 100, the subunit cables 104, and/or the tether cables 114 may vary according to the number of optical fibers 124 enclosed therein, and according to other factors.

In various embodiments, the distribution jacket 106, the subunit jacket 116, and/or the tether jacket 126 may be formed from an extrudable polymer material that includes one or more materials, additives, and/or components embedded in the polymer material that provides fire resistant characteristics, such as relatively low heat generation, low heat propagation, low flame propagation, and/or low smoke production. For example, the distribution jacket 106, the subunit jacket 116, and/or the tether jacket 126 may be made from a flame-retardant PVC. In various embodiments, the fire resistant material may include an intumescent material additive embedded in the polymer material. In other embodiments, the fire resistant material may include a non-intumescent fire resistant material embedded in the polymer material, such as a metal hydroxide, aluminum hydroxide, magnesium hydroxide, etc., that produces water in the presence of heat/fire which slows or limits heat transfer along the length of the distribution cable 100, subunit cables 104, and/or tether cables 114. In certain embodiments, the distribution jacket 106, the subunit jacket 116, and/or the tether jacket 126 may be formed from fire-retardant materials to obtain a desired plenum burn rating. For example, highly-filled PVCs of specified thicknesses can be used to form these components. Other suitable materials include low smoke zero halogen (LSZH) materials such as flame retardant polyethylene and PVDF.

In certain embodiments, the strain-relief component 110 and/or strain-relief component 120 may utilize tensile yarns as tension relief elements that provide tensile strength to the cables 100, 104, 114. In certain embodiments, a preferred material for the tensile yarns is aramid (e.g., KEVLAR®), but other tensile strength materials could be used, such as high molecular weight polyethylenes (e.g., SPECTRA® fiber and DYNEEMA® fiber, Teijin Twaron® aramids, fiberglass, etc.). In certain embodiments, the yarns may be stranded to improve cable performance.

The components of the distribution cable 100, such as the subunit cables 104, can be constructed of selected materials of selected thicknesses such that the distribution cable 100 achieves plenum burn ratings according to desired specifications. The subunit cables 104 can also be constructed so that they are relatively robust, such that they are suitable for field use, while also providing a desired degree of accessibility. For example, in certain embodiments, the subunit cables 104 can be constructed with thicker subunit jackets 116 which provide sufficient protection for the fibers such that the subunit jackets 116 may be used as furcation legs.

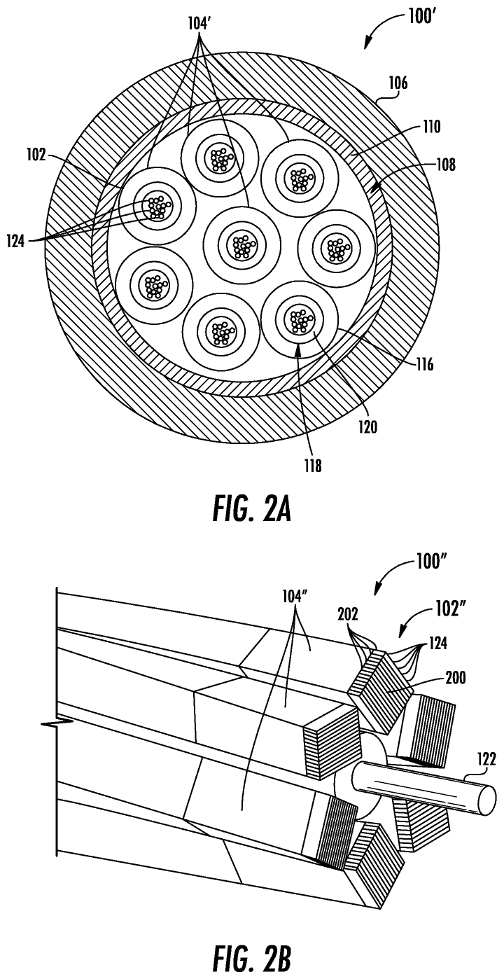

FIG. 2A is a cross-sectional view of an embodiment of the distribution cable 100′ of FIGS. 1A-1B, in accordance with aspects of the present disclosure. Each of the subunit cables 104′ includes optical fibers 124 loosely disposed within the subunit cable 104′ (e.g., in an essentially parallel array). In certain embodiments, the optical fibers 124 may be coated with a thin film of powder (e.g., chalk, talc, etc.) which forms a separation layer that prevents the fibers from sticking to the molten sheath material during extrusion. The subunit cable 104′ may be further encased in an interlocking armor for enhanced crush resistance.

FIG. 2B is a cross-sectional view of another embodiment of the distribution cable 100″. Each of the subunit cables 104″ of the cable bundle 102″ is a stack 200 of fiber ribbons 202. Each fiber ribbon 202 includes a plurality of optical fibers 124. In certain embodiments, as illustrated, the subunit cables 104″ are stranded around a central strength element 122, and/or each subunit cable 104″ is stranded.

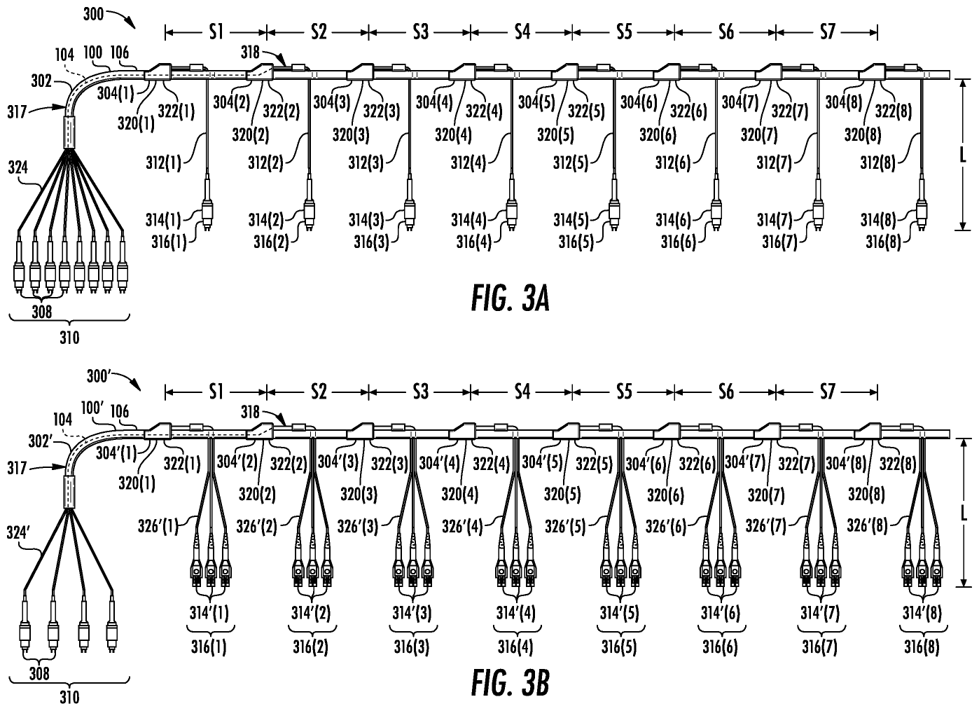

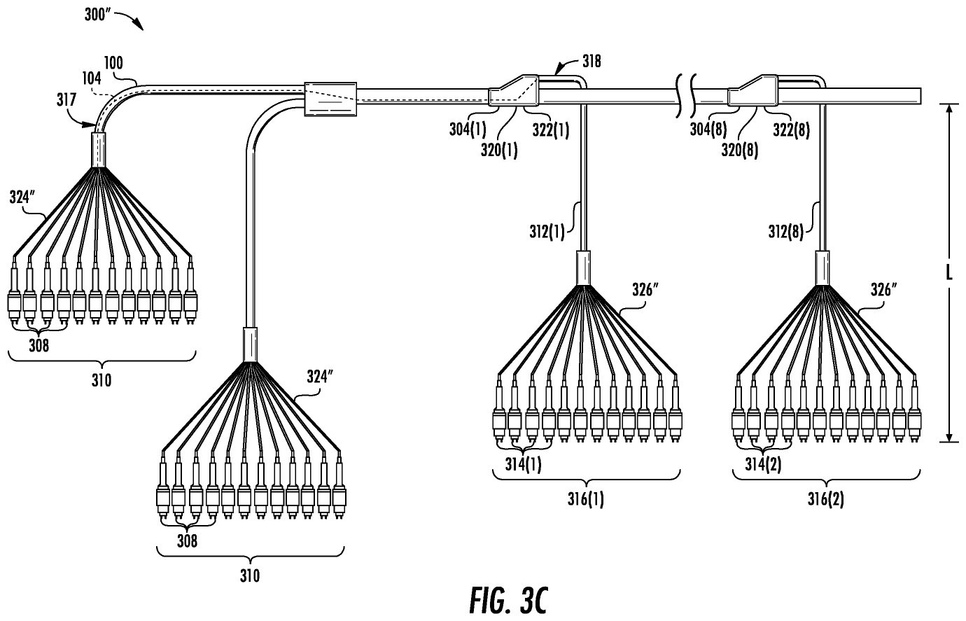

FIGS. 3A-3C are embodiments of a distribution cable assembly 300 incorporating the distribution cable of FIGS. 1A-2B. Referring to FIG. 3A, the distribution cable assembly 300 includes a distribution subunit 302 (may also be referred to herein as a main subassembly) and a plurality of tap subunits 304(1)-304(8) (may also be referred to herein as a branch subassembly, drop subunit, etc.). The distribution subunit 302 includes a distribution cable 100, 100′ (referred to generally herein as distribution cable 100) and distribution connectors 308(1)-308(8) at a distribution end 310 (may also be referred to herein as upstream end). Each of the plurality of tap subunits 304(1)-304(8) includes a tap cable 312(1)-312(8) (may also be referred to herein as a drop cable) and tap connectors 314(1)-314(8) at a tap end 316(1)-316(8) (may also be referred to herein as downstream end). In certain embodiments, subunit cables 104 extend from the distribution connector 308 to respectively one of the plurality of tap connectors 312(1)-312(8), each at a different tap point 320(1)-320(8) (may also be referred to herein as drop point, terminated access point, etc.) along a length of the distribution cable 100. For example, subunit cable 104 extends from the distribution connector 308 through the distribution cable 100 to the tap connector 314(2). The spacing between tap points 320(1)-320(8) depends on the application and cabling requirements.

The distribution connectors 308(1)-308(8) are in optical communication with the tap connectors 314(1)-314(8) (may be referred to generally as tap connectors 314), where the distribution cable assembly 300 is pre-connectorized, such as for connection to a patch panel (e.g., at a goalpost). Any conventional or yet-to-be developed optical connector or connectorization scheme may be used in accordance with the present disclosure, including, but not limited to, small (e.g., LC) and multi-fiber (e.g., MPO/MTP) connectors as commercially available. The distribution cable assembly 300 includes a distribution portion 317 of the subunit cable 104 that extends from the distribution connectors 308(1)-308(8) through the distribution cable 100. The distribution cable assembly 300 further includes tap portions 318(1)-318(8) of the subunit cable 104 that extends from the distribution cable 100 to the tap connectors 312(1)-312(8). A junction shell 322(1)-322(8) at each tap point 320(1)-320(8) facilitates and protects routing of the subunit cable 104 from the distribution cable 100.

In certain embodiments, as illustrated in FIG. 3A, the distribution subunit 302 includes a distribution tether 324 at the distribution end 310. The distribution tether 324 may be pre-connectorized, and extend a predetermined length L from the distribution jacket 106. Further, the distribution tether 324 includes distribution connectors 308(1)-308(8) coupled to ends of the distribution tether 324. Whether to include a distribution tether 324 may depend on the cabling requirements (e.g., routing requirements, connector requirements, etc.). Similarly, the tap subunits 304(1)-304(8) are pre-connectorized such that the tap cables 312(1)-312(8) extend a predetermined length L from the distribution jacket 106. Further, the tap subunits 304(1)-304(8) include tap connectors 312(1)-312(8) coupled to an end of the tap subunits 304(1)-304(8). In certain embodiments, each of the distribution connectors 308(1)-308(8) and/or tap connectors 314(1)-314(8) includes an MPO (multi-fiber push on) connector, which is configured for multi-fiber cables including multiple sub-units of optical fibers (e.g., between four to 24 fibers). A type of MPO connector may be an MTP connector that may hold 12 fibers and is commercially available by US CONEC LTD. of Hickory, N.C. MPO connectors may hold 12 fibers, 24 fibers, 36 fibers, or 96 fibers, or another number as suitable per the design parameters for the pre-configured cable.

In certain embodiments, as illustrated in FIG. 3B, the distribution cable assembly 300′ includes the distribution subunit 302′ with a distribution tether 324′ at the distribution end 310, which is pre-connectorized with MPO connectors. Further, the tap subunits 304′(1)-304′(8) includes tap tethers 326′(1)-326′(8) at the tap ends 316′(1)-316′(8), which is pre-connectorized with tap connectors 314′(1)-314′(8) including LC connectors. An LC connector may include a simple design for a single optical fiber for transmission in a single direction (e.g., transmit or receive) or when a multiplex data signal is used for bi-directional communication over a single optical fiber. An LC connector may alternatively use a duplex design including connection to a pair of optical fibers for when separate transmit and receive communications are required between devices, for example.

FIG. 3C is a schematic view of another embodiment of a preconnectorized distribution cable assembly 300″ illustrating multiple distribution tethers 324″ and multiple tap tethers 326″. Such configurations may be used to increase fiber density and/or for certain routing configurations, such as by routing each distribution tether 324″ to each tap tether 326″.

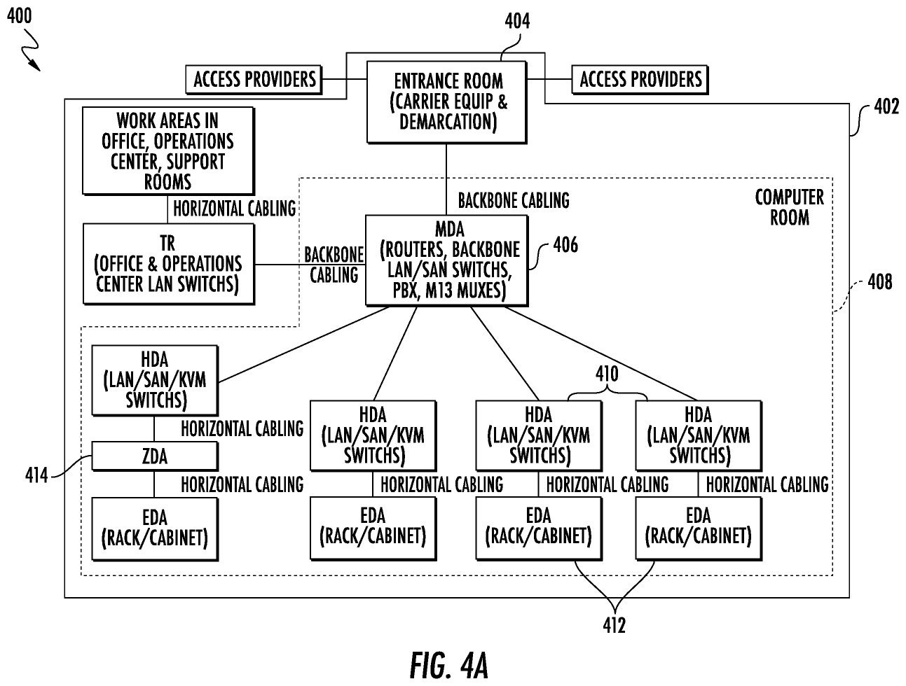

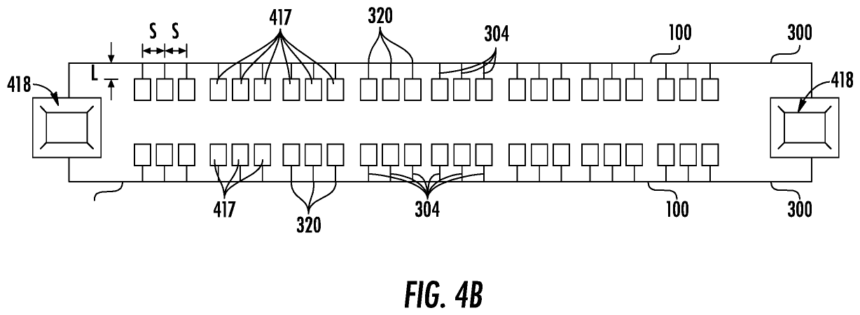

FIG. 4A is a schematic view of a data center, in accordance with aspects of the present disclosure. In particular, FIG. 4A illustrates a topology of an exemplary data center 400. The data center 400 includes a set of spaces delineated by function which may be housed in a single building 402. For example, the data center may include one or more entrance rooms 404 or entry points. The entrance room 404 is conventionally the space used for interfacing the structured cabling infrastructure of the data center 400 with inter-building cabling. Each entrance room 404 may be configured to act as a termination point for external optical connections to a wide area network (WAN) and/or other data center buildings 400. The data center 400 may optionally have multiple entrance rooms 404 to provide redundancy or to avoid exceeding maximum cable lengths. The entrance room 404 may contain carrier equipment and serve as the demarcation between that carrier equipment and the data center.

The entrance room 404 communicates with a Main Distribution Area (MDA) 406. The MDA 406 may be separately contained in a dedicated computer room 408. In some cases, the entrance room 404 may be combined with the MDA 406. The MDA 406 is the central point of distribution for the data center structured cabling system. Core routers, core Local Area Network (LAN) switches, core Storage Area Network (SAN) switches, and Private Branch eXchange (PBX) may be located in the MDA 406. The MDA 406 may serve one or more Horizontal Distribution Areas (HDAs) 410 or Equipment Distribution Areas (EDAs) 412. The HDA 410 may include LAN switches, SAN switches, and Keyboard/Video/Mouse (KVM) switches for equipment located in the EDAs 412. In a small data center, the MDA 406 may serve the EDAs 412 directly with no HDAs 410. However, most data centers, particularly large data centers, will have multiple HDAs 410. The EDA 412 contains the end equipment, including computer systems and telecommunications equipment typically organized in racks or cabinets. In some cases, a Zone Distribution Area (ZDA) 414 may be provided between the HDA 410 and the EDA 412 to provide for frequent reconfiguration and flexibility.

The cabling topology for a data center includes many different types of cabling, such as high fiber count cables (e.g., 3,000+ fibers) coming into the data center and all the structured cabling to connect all of the switches and equipment internal to the data center. The data center structured cabling may be categorized as backbone cabling and horizontal cabling.

FIG. 4B is a schematic view of equipment racks and distribution cables in a data center, in accordance with aspects of the present disclosure. A pre-configured and preconnectorized cable such as distribution cable assembly 300, 300′, 300″ (referred to herein generally as distribution cable assembly 300) may be used to connect the servers 417 in the racks or cabinets in the EDA 412 to the MDA via one or more edge of rack units 418 (also referred to as goalposts). The exact drop or tap locations and run lengths for the individual tap subunits 304, 304′, 304″ (referred to herein generally as tap subunit 304) may be pre-engineered and pre-connectorized to replace the many individual cables typically provided. In conventional systems, each cabinet would require a different cable. Comparatively, disclosed herein are distribution cable assemblies 300 with a single distribution cable 100 with multiple tap points 320, thereby greatly reducing cabling clutter and simplifying installation.

The most efficient optical infrastructure is one in which all or most of the components are preterminated in the factory and the cables are designed to fit efficiently in the confined spaces of the datacenter without excess cable. In certain embodiments, all connectors are installed and tested in the factory and packaged such that components are not damaged during installation. The installer simply unpacks the components, pulls the preconnectorized cable assembly into place, snaps in all of the connectors and the system is up and running. Accordingly, the cable assembly 300, 300′, 300″ depicted in FIGS. 1A-3C may be particularly suitable for the structured cabling requirements of a datacenter.

In certain embodiments, the plurality of tap subunits 304 (e.g., premanufactured) of the distribution cable assembly 300 are spaced apart by a predetermined distance S and/or of a predetermined length L based on, for example, location in a datacenter and/or distance to specific equipment, etc. In particular, the distribution cable assembly 300 could be manufactured such that each individual tap subunit 304 has a predetermined length L according to the configuration of the data center and where along the distribution cable 100 the tap subunit 304 will branch away. Further, the tap subunits 304 may be premanufactured such that each has a predetermined length L according to the configuration of the data center (e.g., spacing S between servers) and location along the distribution cable.

Although the concepts of the present disclosure are described herein with primary reference to a data center, it is contemplated that the concepts will enjoy applicability to any outdoor and indoor waveguide system associated with digital infrastructure data including an infrastructure layout and housing server rack systems. For example, and not by way of limitation, it is contemplated that the concepts of the present disclosure will enjoy applicability to indoor warehouses and/or commercial buildings.

### Methods of Making Preconnectorized Cable Assemblies

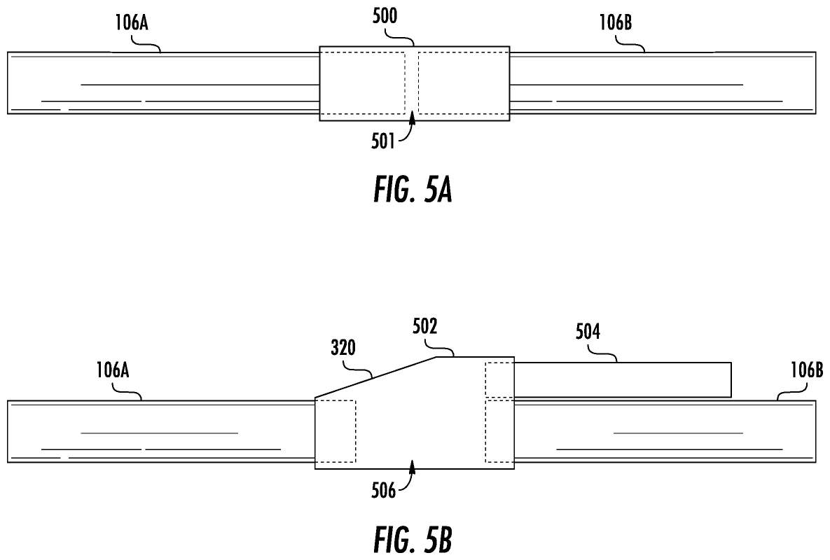

FIGS. 5A-5B are views of joining jacket segments together, which can be used for any coupling herein. In particular, FIG. 5A is a side view of a coupling shell 500 attaching two distribution jackets 106A-106B with a gap 501 positioned therebetween. In certain embodiments the distribution jackets 106A-106B are joined by welding, adhesives (e.g., glue), etc.

FIG. 5B is a side view of a junction shell 502 attaching two distribution jackets 106A-106B and a tap jacket 504. In both FIGS. 5A-5B the two distribution jackets 106A-106B are illustrated as separated by a side opening 506 to allow routing of a subunit cable 104 (see FIGS. 1A-2B). In certain embodiments, the two distribution jackets 106A-106B are integrally joined together with a side opening 506 that extends only partially around the circumference of the two distribution jackets 106A-106B. The coupling shell 500 and/or the junction shell 502 cover the side opening 506, such as to seal and close the tap point 320 along the distribution cable 100 (see FIG. 1A and 3A-3C). In certain embodiments, the coupling shell 500 and/or the junction shell 502 may be formed through injection molding, for example, wherein the coupling shell 500 and/or the junction shell 502 is formed of bifurcated halves that snap together to seal the tap point 320. However, any other suitable method of providing a protective seal is envisioned including low-pressure overmolding or a heat shrink.

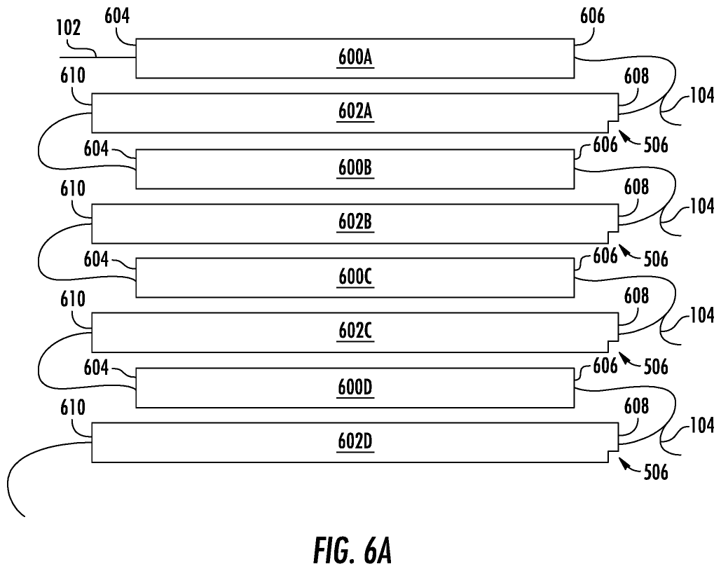

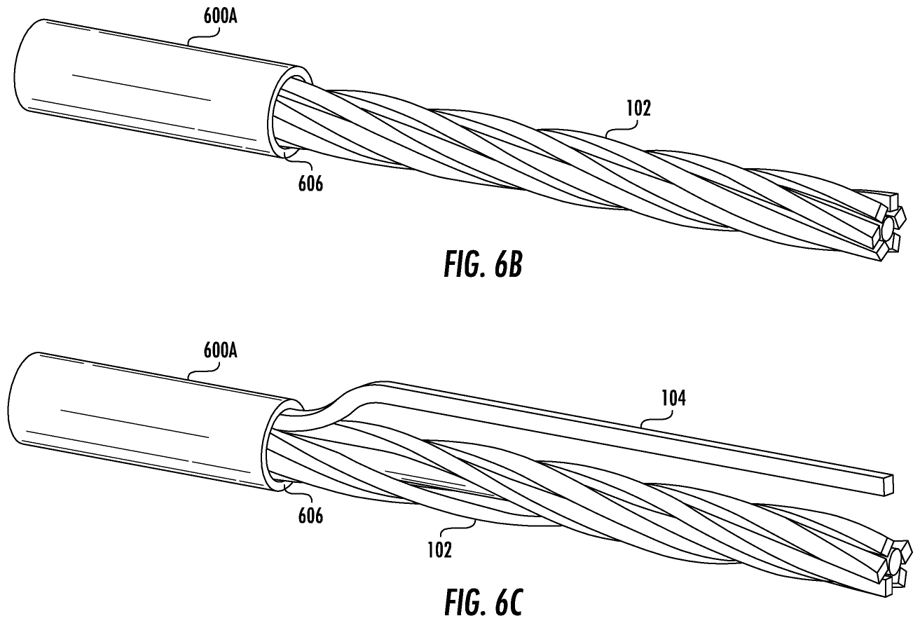

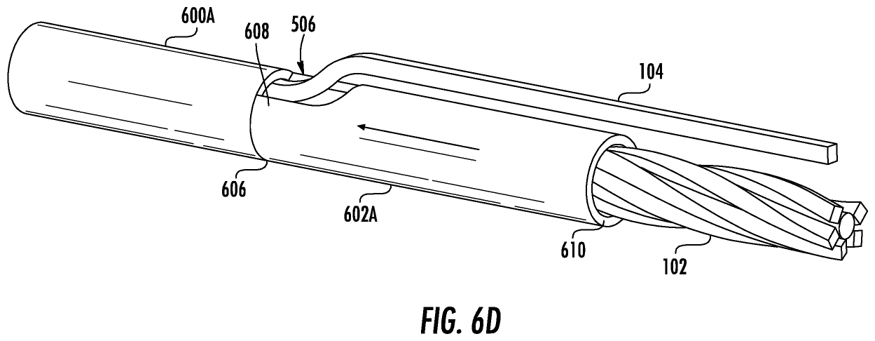

FIGS. 6A-6D are views illustrating assembly of a distribution cable assembly by consecutive addition of jacket segments 600A-602D around a cable bundle 102. Referring to FIG. 6A, in certain embodiments, the distribution cable 100 (see FIG. 1A and 3A-3C) is manufactured such that the distribution jacket 106 (see FIG. 1A and 3A-3C) is empty and cut into shorter jacket segments 600A-602D, such as according to where the tap points 320 are required. Each through jacket segment 600A-600D includes a first end 604 and a second end 606 opposite thereto. Each windowed jacket segment 602A-602D (may also be referred to herein as insert segments, insert jacket segments, etc.) includes a first end 608 and a second end 610 opposite thereto.

In certain embodiments, some of the jacket segments 600A-602D are through jacket segments 600A-600D (referred to generally as through jacket segment 600) without a side opening, and some of the jacket segments are windowed jacket segments 602A-602D (referred to generally as windowed jacket segment 602), where each windowed jacket segment 602A-602D includes a side opening 506 at the first end 608 extending at least partially around a circumference of the windowed jacket segment 602A-602D. In certain embodiments, all of the jacket segments 600A-602D are windowed jacket segments 602. A longitudinal length of each of the jacket segments 600A-602D may be configured according to where the tap points 320 are required.

In certain embodiments, the cable bundle 102 is fed through all of the jacket segments 600A-602D. Then, for example, a subunit cable 104 is cut at a second end 610 of a windowed jacket segment 602A and withdrawn through the windowed jacket segment 602A to the first end 604 of the through jacket segment 600A. Accordingly, in certain embodiments, the length of the windowed jacket segment 602A is based on the desired length of the tap portion 318 of the subunit cable 104. Of course, the subunit cable 104 may be tailored further (e.g., additionally cut) as needed. The process may be repeated as necessary based on the number of tap points 320 to be branched from the distribution cable 100. In such a configuration, the lengths of the through jacket segment 600 and the windowed jacket segment 602 determines the relative positions of the side openings 506 (and the relative positions of the tap points 320). In certain embodiments, these relative positions are preconfigured based on a predetermined length (such as corresponding to a data center layout).

Referring to FIG. 6B, in certain embodiments, for example, the through jacket segment 600A is positioned around the cable bundle 102. Referring to FIG. 6C, the subunit cable 104 is then cut from the cable bundle 102 and peeled away from the cable bundle 102. In other words, the subunit cable 104 is cut at a distance from the second end 606 of the through jacket segment 600A.

Referring to FIG. 6D, the first jacket segment 602A is then positioned around the cable bundle 102 with the first end 608 of the windowed jacket segment 602A positioned proximate the second end 606 of the through jacket segment 600A and attached thereto (e.g., by coupling shell 500, junction shell 502, glue, welding, etc.). The subunit cable 104 is positioned within the side opening 506 of the windowed jacket segment 602A. This process repeats for each of the remaining jacket segments 600A-602D until the distribution cable 100 is assembled (and all of the jacket segments 600A-602D are attached to one another).

In certain embodiments, rather than cut the subunit cable 104 from the cable bundle 102, the subunit cables 104 are instead individually fed down each of the jacket segments 600A-602D. In such a configuration, the cable bundle 102 is formed during the assembly of the distribution cable 100 rather than pulled from the cable bundle.

In certain embodiments, pre-cutting the distribution jacket 106 into smaller segments and placed close together may require less space to manufacture (e.g., have a smaller footprint).

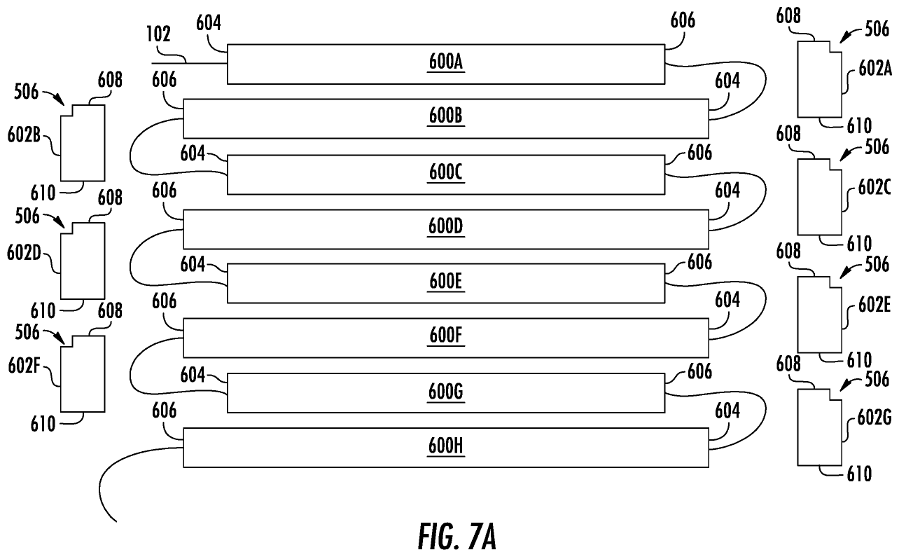

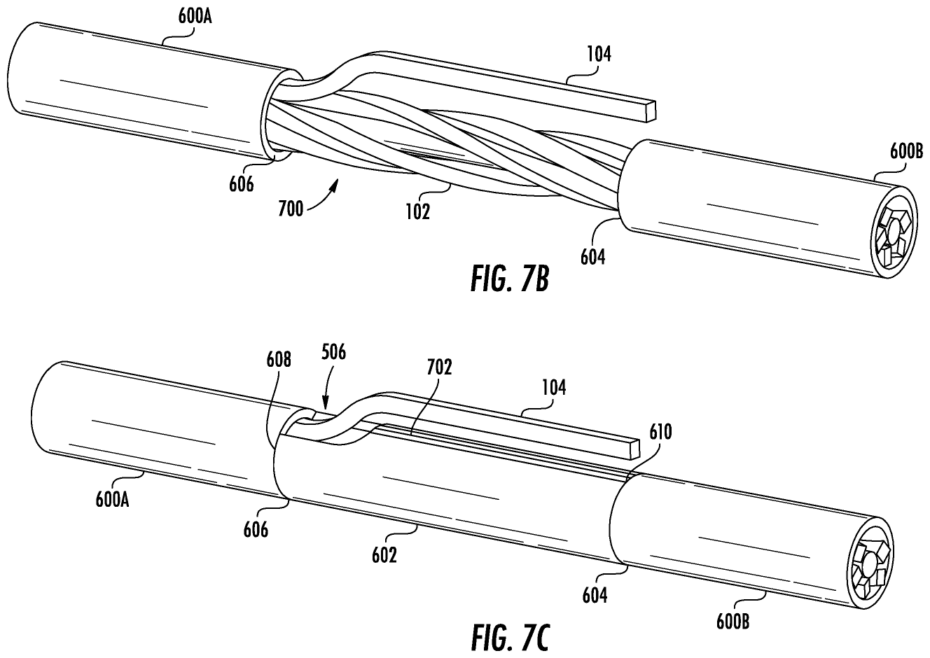

FIGS. 7A-7D are views illustrating assembly of a distribution cable assembly by insertion of windowed jacket segments 602A-602D around a cable bundle 102. The assembly includes similar features as those discussed above with respect to FIGS. 6A-6D except where otherwise noted. Referring to FIG. 7A, in certain embodiments, the distribution cable 100 (see FIG. 1A and 3A-3C) is manufactured such that the distribution jacket 106 (see FIG. 1A and 3A-3C)is empty and cut into shorter through jacket segments 600A-600H, such as according to where the tap points 320 are required. The cable bundle 102 is fed through all the through jacket segments 600A-600H.

Then, for example, a subunit cable 104 (see FIGS. 1A-2B) is cut at a second end 606 of a first through jacket segment 600A and withdrawn through the through jacket segment 600A to the first end 604. Accordingly, in certain embodiments, the length of the through jacket segment 600A is based on the desired length of the tap portion 318 of the subunit cable 104. Of course, the subunit cable 104 may be tailored further (e.g., additionally cut) as needed. The process may be repeated as necessary based on the number of tap points 320 to be branched from the distribution cable 100.

In certain embodiments, after the first through jacket segment 600A is positioned over the cable bundle 102, the subunit cable 104 is cut from the cable bundle 102 and peeled away from the cable bundle 102. The second through jacket segment 600B is then positioned around the cable bundle 102 with the first end 604 of the second jacket segment 600B positioned proximate the second end 606 of the first through jacket segment 600A.

Regardless of which process is used, windowed jacket segments 602 are then positioned between at least some of the through jacket segments 600 and around the cable bundle 102. The through jacket segments 600 and the windowed jacket segments 602 are then attached to one another (e.g. by coupling shell 500, junction shell 502, welding, glue, etc.). In such a configuration, the lengths of the through jacket segment 600 and the windowed jacket segment 602 determine the relative positions of the side openings 506 (and the relative positions of the tap points 320 (see FIGS. 3A-3C)). In certain embodiments, these relative positions are preconfigured based on a predetermined length (such as corresponding to a data center layout).

Referring to FIG. 7B, an access window 700 is formed between the first through jacket segment 600A and the second through jacket segment 600B with a subunit cable 104 peeled away from the cable bundle 102. Referring to FIG. 7C, the windowed jacket segment 602 includes a side opening 506 proximate the first end 608 with a longitudinal slit 702 extending from the first end 608 of the second through jacket segment 600B to the second end 610 of the first through jacket segment 600A. This slit 702 could be formed using a tool and/or rip cord, etc. Using this slit 702, the windowed jacket segment 602 is inserted between the first and second through jacket segments 600A-600B and positioned around the cable bundle 102 with the subunit cable 104 extending out of the side opening 506. The longitudinal slit 702 is then welded or glued thereafter. In certain embodiments, the length of the access window 700 (and accordingly the length of the windowed jacket segment 602) is the desired length of the subunit cable 104. As a result, the subunit cable can be cut proximate the first end 604 of the second through jacket segment 600B and peeled from the subunit cable 102 from the first end 604 of the second through jacket segment 600B to the second end 606 of the first through jacket segment 600A.

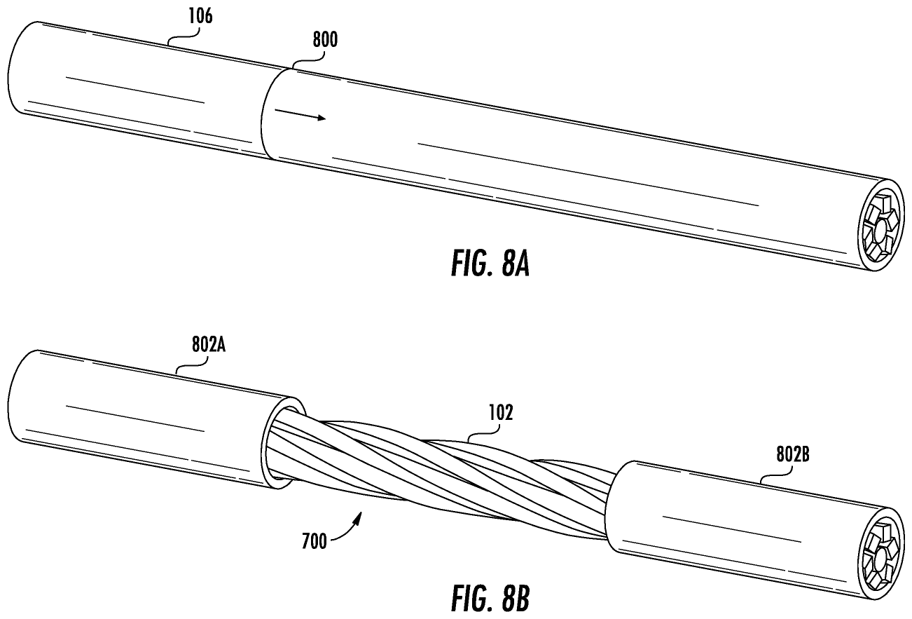

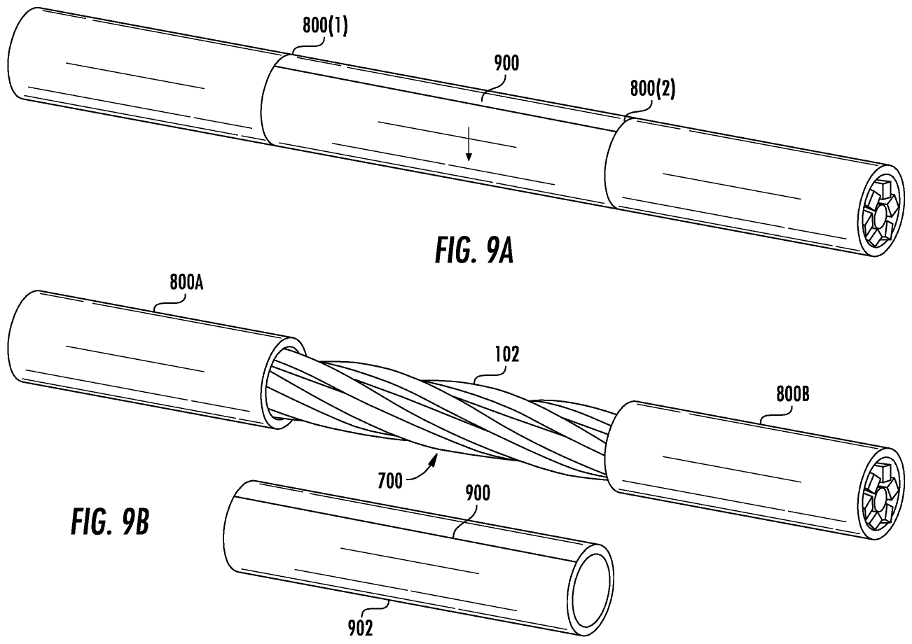

FIGS. 8A-8B are views of another embodiment of forming an access window 700. Referring to FIG. 8A, a distribution jacket 106 is positioned around the cable bundle 102 and a ring cut 800 is formed in the distribution jacket 106. Referring to FIG. 8B, a first base jacket portion 802A is then slid from a second base jacket portion 802B to form the first access window 700. Subsequently, the windowed jacket segment 602 may then be inserted between the base jacket portions 802A-802B as previously discussed.

FIGS. 9A-9B are views of another embodiment of forming an access window 700. Referring to FIG. 9A, a distribution jacket 106 is positioned around the cable bundle 102 and two ring cuts 800(1)-800(2) are formed in the distribution jacket 106. A slit 900 is then formed in the distribution jacket 106 between the two ring cuts 800(1)-800(2). Referring to FIG. 8B, a base jacket segment 902 is then removed from between two base jacket portions 800A-800B by the slit 900 to form the access window 700.

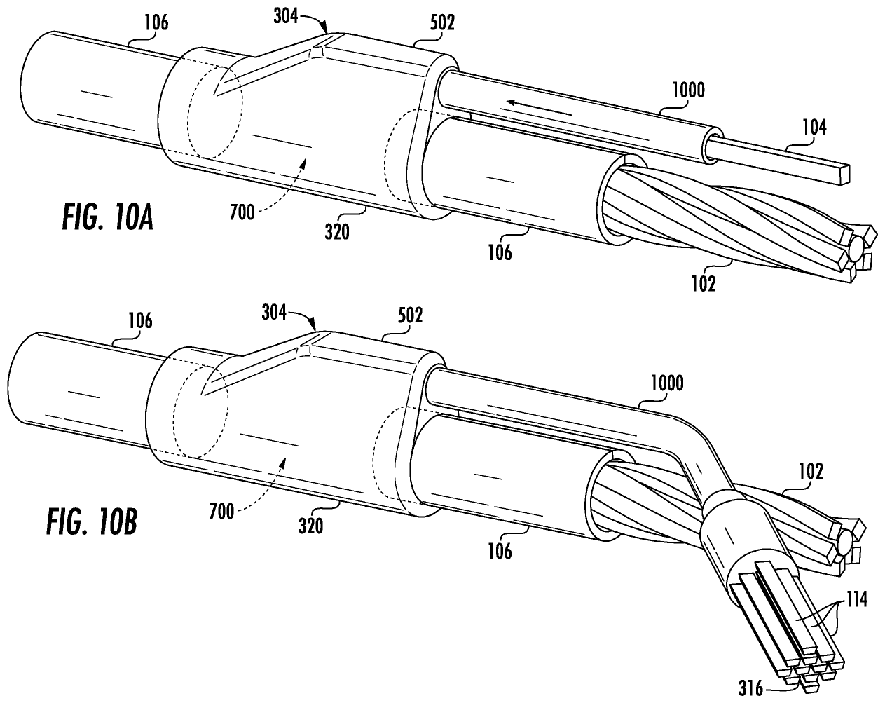

FIGS. 10A-10B are views illustrating making a tap subunit 304. Referring to FIG. 10A, a junction shell 502 is positioned at the tap point 320, such that the distribution cable 106 extends through the junction shell 502 and a subunit cable 104 extends from the junction shell 502. A tap jacket 1000 (may also be referred to herein as a furcation tube) is positioned around (e.g., slid over) the subunit cable 104. In certain embodiments, the length of the access window 700 is large enough to permit withdrawal of one of the subunit cables 104 and/or small enough to be covered by a junction shell 502. Referring to FIG. 10B, in certain embodiments, the tap end 316 is furcated into separate tether cables 114. The tap end 316 may be connectorized thereafter.

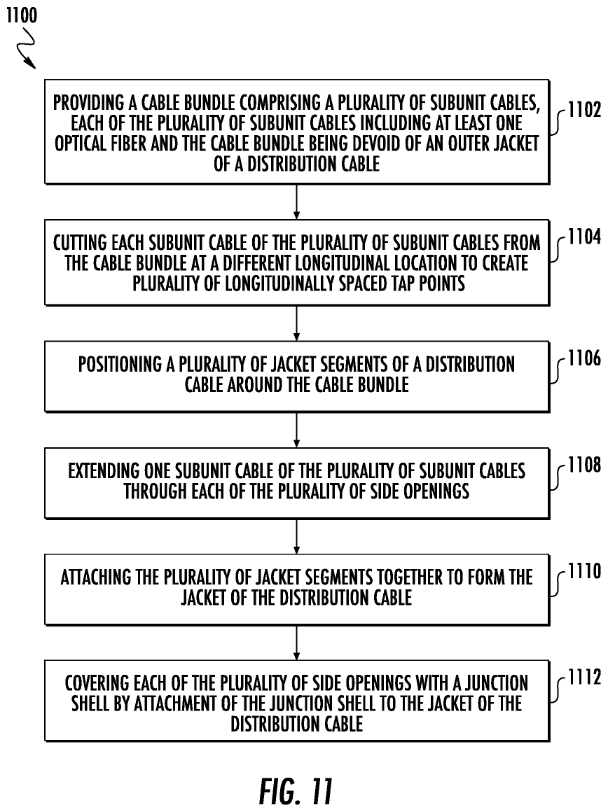

FIG. 11 is a flowchart 1100 of steps for making a distribution cable assembly 300 using consecutive addition of jacket segments. Step 1102 includes providing a cable bundle 102 comprising a plurality of subunit cables 104. Each of the plurality of subunit cables 104 includes at least one optical fiber. The cable bundle is devoid of an outer jacket of a distribution cable 100.

Step 1104 includes cutting each subunit cable of the plurality of subunit cables 104 from the cable bundle 102 at a different longitudinal location to create a plurality of longitudinally spaced tap points 320. Step 1106 includes positioning a plurality of jacket segments 600A-602D of a distribution cable 100 around the cable bundle 102. In certain embodiments, at least one of the plurality of jacket segments 600A-602D includes a plurality of side openings 506.

Step 1108 includes extending one subunit cable of the plurality of subunit cables 104 through each of the plurality of side openings 506. Step 1110 includes attaching the plurality of jacket segments 600A-602D together to form the jacket of the distribution cable 100. In certain embodiments, the plurality of jacket segments 600A-602D are attached together by at least one of welding or gluing. Step 1112 includes covering each of the plurality of side openings 506 with a junction shell 502 by attachment of the junction shell 502 to the jacket of the distribution cable 100.

In certain embodiments, the method further includes sliding a tap jacket 1000 over at least a portion of each of the plurality of subunit cables 104 extending through the plurality of side openings 506. In certain embodiments, the method further includes furcating a plurality of fibers of each subunit cable of the plurality of subunit cables 104 into tether subunits. In certain embodiments, the method further includes connectorizing each of the plurality of subunit cables 104 with a distribution connector 308 at a distribution end 310 and a tap connector 314 at a tap end 316. In certain embodiments, the plurality of subunit cables 104 comprises eight subunit cables 104, each subunit cable 104 including 12 fibers furcated into six 2-fiber tether subunits, each of the plurality of subunit cables 104 extending through a respective one of the plurality of side openings 506.

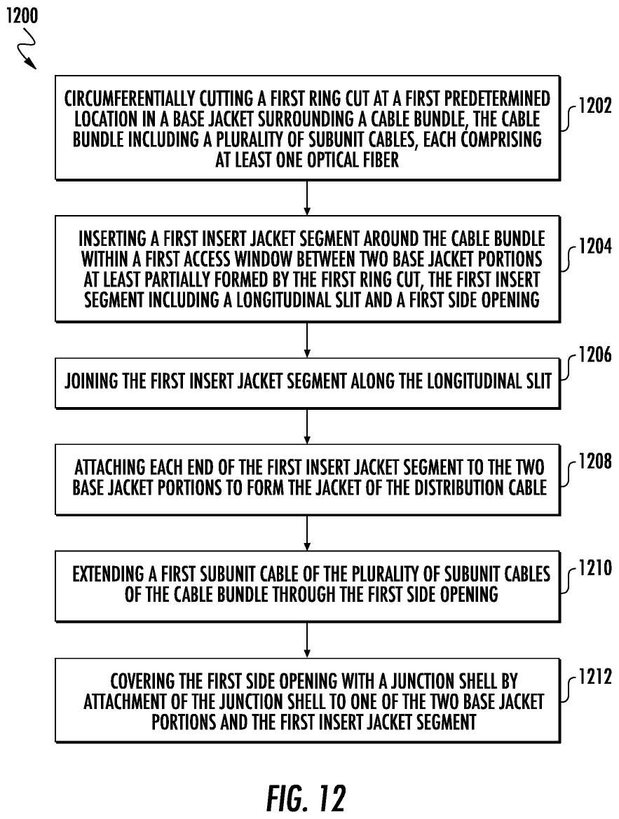

FIG. 12 is a flowchart 1200 of steps for making a distribution cable assembly 300 using insertion of jacket segments 600A-602D. Step 1202 includes circumferentially cutting a first ring cut 800(1) at a first predetermined location in a base jacket surrounding a cable bundle 102. The cable bundle 102 includes a plurality of subunit cables 104, each of the plurality of subunit cables 104 comprising at least one optical fiber.

Step 1204 includes inserting a first insert jacket segment around the cable bundle 102 within a first access window 700 between two base jacket portions 800A-800B at least partially formed by the first ring cut 800(1). The first insert jacket segment includes a longitudinal slit 702 and a first side opening 506. In certain embodiments, the first access window 700 is formed by sliding the two base jacket portions 800A-800B apart. In certain embodiments, the method further includes circumferentially cutting a second ring cut 800(2) to form a base jacket segment 902 between the first ring cut 800(1) and the second ring cut 800(2), longitudinally cutting a slit 702 in the base jacket segment 902 between the first ring cut 800(1) and a second ring cut 800(2), and removing the base jacket segment 902 of the base jacket from around the cable bundle 102 to form the first access window 700.

In certain embodiments, the method further includes cutting the first subunit cable 104 of the plurality of subunit cables 104 from the cable bundle 102 to create a tap point 320, and extending the first subunit cable of the plurality of subunit cables 104 through the first side opening.

Step 1206 includes joining the first insert jacket segment along the longitudinal slit 702. Step 1308 includes attaching each end of the first insert jacket segment to the two base jacket portions 800A-800B to form the jacket of the distribution cable 100. In certain embodiments, the first insert jacket segment is attached to the two base jacket portions 800A-800B of the base jacket by at least one of welding or gluing.

Step 1210 includes extending a first subunit cable of the plurality of subunit cables 104 of the cable bundle 102 through the first side opening. Step 1212 includes covering the first side opening with a junction shell 502 by attachment of the junction shell 502 to one of the two base jacket portions 800A-800B and the first insert jacket segment.

In certain embodiments, the method further includes sliding a tap jacket 1000 over at least a portion of the first subunit cable of the plurality of subunit cables 104 extending through the first side opening 506. In certain embodiments, the method further includes furcating a plurality of fibers of the first subunit cable of the plurality of subunit cables 104 into tether subunits. In certain embodiments, the method further includes connectorizing the first subunit cable of the plurality of subunit cables 104 with a distribution connector 308 at a distribution end 310 and a tap connector 314 at a tap end 316. In certain embodiments, the plurality of subunit cables 104 comprises eight subunit cables 104, each subunit cable 104 including 12 fibers furcated into six 2-fiber tether subunits, each of the plurality of subunit cables 104 extending through a respective one of the plurality of side openings 506.

It will be apparent to those skilled in the art that various modifications and variations can be made without departing from the spirit or scope of the invention.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163.

Many modifications and other embodiments of the concepts in this disclosure will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of making a distribution cable assembly, comprising:
providing a cable bundle comprising a plurality of subunit cables, each of the plurality of subunit cables comprising at least one optical fiber, the cable bundle devoid of an outer jacket of a distribution cable;
positioning a plurality of jacket segments of a distribution cable around the cable bundle; and
attaching the plurality of jacket segments together to form the jacket of the distribution cable.

2. The method of claim 1, wherein the plurality of jacket segments are attached together by at least one of welding or gluing.

3. The method of claim 1, wherein at least one of the plurality of jacket segments includes a plurality of side openings.

4. The method of claim 3, further comprising cutting each subunit cable of the plurality of subunit cables from the cable bundle at a different longitudinal location to create a plurality of longitudinally spaced tap points.

5. The method of claim 4, further comprising extending one subunit cable of the plurality of subunit cables through each of the plurality of side openings.

6. The method of claim 3, further comprising covering each of the plurality of side openings with a junction shell by attachment of the junction shell to the jacket of the distribution cable.

7. The method of claim 3, further comprising sliding a tap jacket over at least a portion of each of the plurality of subunit cables extending through the plurality of side openings.

8. The method of claim 1, further comprising furcating a plurality of fibers of each subunit cable of the plurality of subunit cables into tether subunits.

9. The method of claim 1, further comprising connectorizing each of the plurality of subunit cables with a distribution connector at a distribution end and a tap connector at a tap end.

10. The method of claim 1, wherein the plurality of subunit cables comprises eight subunit cables, each subunit cable including twelve fibers furcated into six 2-fiber tether subunits, each of the plurality of subunit cables extending through a respective one of the plurality of side openings.

11. A method of making a distribution cable assembly, comprising:
circumferentially cutting a first ring cut at a first predetermined location in a base jacket surrounding a cable bundle, the cable bundle comprising a plurality of subunit cables, each of the plurality of subunit cables comprising at least one optical fiber;
inserting a first insert jacket segment around the cable bundle within a first access window between two base jacket portions at least partially formed by the first ring cut, the first insert jacket segment comprising a longitudinal slit and a first side opening;
joining the first insert jacket segment along the longitudinal slit;
attaching each end of the first insert jacket segment to the two base jacket portions to form the jacket of the distribution cable; and
extending a first subunit cable of the plurality of subunit cables of the cable bundle through the first side opening.

12. The method of claim 11, further comprising forming the first access window by sliding the two base jacket portions apart.

13. The method of claim 11, further comprising:
circumferentially cutting a second ring cut to form a base jacket segment between the first ring cut and the second ring cut;
longitudinally cutting a slit in the base jacket segment between the first access window and a second access window; and
removing the base jacket segment of the base jacket from around the cable bundle to form the first access window.

14. The method of claim 11, wherein the first insert jacket segment is attached to the two base jacket portions of the base jacket by at least one of welding or gluing.

15. The method of claim 14, further comprising:
cutting the first subunit cable of the plurality of subunit cables from the cable bundle to create a tap point; and
extending the first subunit cable of the plurality of subunit cables through the first side opening.

16. The method of claim 11, further comprising covering the first side opening with a junction shell by attachment of the junction shell to one of the two base jacket portions and the first insert jacket segment.

17. The method of claim 11, further comprising sliding a tap jacket over at least a portion of the first subunit cable of the plurality of subunit cables extending through the first side opening.

18. The method of claim 11, further comprising furcating a plurality of fibers of the first subunit cable of the plurality of subunit cables into tether subunits.

19. The method of claim 11, further comprising connectorizing the first subunit cable of the plurality of subunit cables with a distribution connector at a distribution end and a tap connector at a tap end.

20. The method of claim 11, wherein the plurality of subunit cables comprises eight subunit cables, each subunit cable including twelve fibers furcated into six 2-fiber tether subunits, each of the plurality of subunit cables extending through a respective one of a plurality of side openings formed in the jacket by a plurality of insert jacket segments.
